(19) United States
(12) Patent Application Publication
(10) Pub. No.: US 2013/0258108 A1
(43) Pub. Date: Oct. 3, 2013

(54) Road Surface Shape Recognition System and Autonomous Mobile Apparatus Using Same

(71) Applicants: Yukihiko Ono, Hitachinaka (JP); Ryoko Ichinose, Tsukuba (JP); Kenjiro Yamamoto, Matsudo (JP); Yoshitaka Hara, Tsukuba (JP); Akira Oshima, Tsukuba (JP)

(72) Inventors: Yukihiko Ono, Hitachinaka (JP); Ryoko Ichinose, Tsukuba (JP); Kenjiro Yamamoto, Matsudo (JP); Yoshitaka Hara, Tsukuba (JP); Akira Oshima, Tsukuba (JP)

(73) Assignee: Hitachi, Ltd., Chiyoda-ku, Tokyo (JP)

(21) Appl. No.: 13/991,463

(22) PCT Filed: Dec. 24, 2010
(86) PCT No.: PCT/JP2010/073400

§ 371 Date: Jun. 4, 2013

(51) Int. Cl. H04N 7/18

(52) U.S. Cl. CPC H04N 7/18
USPC 348/148

(57) ABSTRACT

Disclosed is a road surface shape recognition system adapted to recognize a shape of a road surface and obstacles present thereupon, even when the road surface is illuminated with extraneous light of a plurality of wavelengths from illumination lamps, street lamps, electric signboards, and the like.

The road surface shape recognition system for recognizing the shape of the road surface ahead of a vehicle includes: wavelength region calculation means for detecting the extraneous light from a plurality of areas on the road surface, and thereby determining a wavelength region of the extraneous light having the lowest intensity; irradiation means for irradiating each of the areas on the road surface selectively with light of one of a plurality of wavelength regions; irradiation control means for selecting, from the light of the plurality of wavelength regions that can be selectively irradiated from the irradiation means, light having a wavelength corresponding to the wavelength region of the weakest extraneous light, the wavelength region being determined by the wavelength region calculation means, and makes the irradiation means emit the selected light; imaging means for imaging the road surface; and road surface shape calculation means for calculating the shape of the road surface from an image that the imaging means acquires when the irradiation means is irradiating one of the areas on the road surface with the light of the wavelength selected by the irradiation control means.

### TECHNICAL FIELD

The present invention relates to a road surface shape recognition system intended to recognize a shape of, and obstacles present on, a road surface in a traveling direction of a moving apparatus such as a vehicle. The invention also relates to an autonomous mobile apparatus that uses the system.

### BACKGROUND ART

A road surface shape recognition system capable of recognizing a road shape by imaging a white lane marking by use of a vehicle-mounted camera, processing the acquired image, and extracting a shape of the white lane marking from the image, is traditionally known, as disclosed in following Patent Document 1, for example.

Also known is a road surface shape recognition system contemplated so that in order to become able to well recognize the inclinations, surface undulations, and other geometric factors of a road not having a white lane marking thereupon, or of a road having a white lane marking thereupon, but in unclear form, the system projects a pattern image onto the road surface, processes an image obtained of the road surface onto which the pattern image has been projected, detects a shape of the pattern image, and hence determines a shape of the road from the detected shape of the pattern image. Such a system is disclosed in following Patent Document 2, for example.

### PRIOR ART DOCUMENTS

### Patent Documents

Patent Document 1: JP-2003-308534-A
Patent Document 2: JP-2008-217267-A

### SUMMARY OF THE INVENTION

### Problems to be Solved by the Invention

The road surface shape recognition systems based upon the above conventional techniques, however, has had problems in that when so-called extraneous light from road-illuminating lamps, street lamps, electric signboards, and the like, shines upon the road, especially when the wavelength of the extraneous light and the wavelength of the ex-vehicle illumination light projected for shape recognition or the wavelength of the light of the pattern image projected onto the road surface are close to each other, the system cannot accurately detect the white lane marking or the projected pattern image, and thus that the shapes of the roads under the foregoing states are difficult to accurately recognize.

Accordingly, the present invention has been achieved with consideration for the foregoing problems associated with the conventional techniques, and an object of the invention is to provide a road surface shape recognition system configured to reliably recognize a shape of a road and obstacles present on the road, despite any adverse effects of irradiation with illumination lamps, street lamps, electric signboards, and other lighting provided around the road. The invention is also intended to provide an autonomous mobile apparatus that uses the system.

### Means for Solving the Problems

In order to attain the above object, the present invention provides a road surface shape recognition system used to recognize a shape of a road surface ahead of a vehicle, the system comprising: wavelength region calculation means for detecting extraneous light from a plurality of areas on the road surface, and thereby determining a wavelength region of the extraneous light having the lowest intensity; irradiation means for irradiating each of the areas on the road surface selectively with light of one of a plurality of wavelength regions; irradiation control means for selecting, from the light of the plurality of wavelength regions that can be selectively irradiated from the irradiation means, light having a wavelength corresponding to the wavelength region of the weakest extraneous light, the wavelength region being determined by the wavelength region calculation means, and makes the irradiation means emit the selected light; imaging means for imaging the road surface; and road surface shape calculation means for calculating the shape of the road surface from an image that the imaging means acquires when the irradiation means is irradiating one of the areas on the road surface with the light of the wavelength selected by the irradiation control means.

In another aspect of the above-outlined road surface shape recognition system according to the present invention, the wavelength region calculation means preferably detects extraneous light from an image acquired by the imaging means when the irradiation means is not irradiating the road surface with light, and determines a wavelength region of the extraneous light having the lowest intensity. Furthermore, the imaging means preferably images the road surface while sequentially causing the wavelength region calculation means to execute the detection of the wavelength region of the weakest extraneous light, and the irradiation control means and the irradiation means to execute respectively the selection of light having a wavelength corresponding to the wavelength region of the weakest extraneous light, and irradiation with the selected light. Additionally to the above, the wavelength region calculation means preferably determines, from information relating to a motion of the vehicle, the wavelength region of the weakest extraneous light on a predicted area of the road surface. Moreover, the irradiation means is preferably adapted to irradiate the road surface selectively with the light of the plurality of wavelength regions as a plurality of beams of spot light or slit light.

In yet another aspect of the above-outlined road surface shape recognition system according to the present invention, a size or intervals of the beams of spot light or slit light are preferably changed according to a state of the road surface detected, and the wavelength region calculation means is preferably shared with the imaging means and is fitted with a filter to selectively let the extraneous light from the plurality of areas on the road surface pass through. In addition, the irradiation control means, while sequentially scanning the plurality of areas on the road surface, selects light having a wavelength corresponding to the determined wavelength region of the weakest extraneous light, and makes the irradiation means emit the selected light. Furthermore, the irradiation means preferably includes a galvanometer for emitting the light while sequentially scanning in accordance with a control signal from the irradiation control means.

In addition to the above-outlined road surface shape recognition system, an autonomous mobile apparatus adapted to autonomously move along the road surface while recognizing the shape of the road surface is provided in accordance with the present invention, the apparatus being equipped with the recognition system.

### Effects of the Invention

That is to say, as in the foregoing conventional techniques, when a road is illuminated with the extraneous light emitted from road-illuminating lamps, street lamps, electric signboards, and the like, for example if the wavelength of the extraneous light and the wavelength of ex-vehicle illumination lamps and light of a pattern image projected onto the road surface are close to each other, it is likely that a white lane marking and the projected pattern image will not be accurately detected and thus that a shape of the road surface will not be accurately recognized. The present invention is intended to solve these problems. Even on the road illuminated with such extraneous light of a plurality of wavelengths that is emitted from road-illuminating lamps, street lamps, electric signboards, and the like, the invention enables reliable recognition of the shape of the road surface and obstacles present thereupon, by imaging these targets with light of a wavelength that is substantially free from any influence of the extraneous light.

### BRIEF DESCRIPTION OF THE DRAWINGS

FIG. 1 is a block diagram showing a configuration of a road surface shape recognition system which is a first embodiment of the present invention;

FIG. 2 is an explanatory diagram of spot light irradiation from the road surface shape recognition system mounted on an autonomous mobile vehicle in the first embodiment;

FIG. 3 is a diagram showing a detailed configuration of an irradiation device included in the road surface shape recognition system of the first embodiment;

FIG. 4 is a schematic explanatory diagram of processing in a wavelength region calculation device and irradiation control device included in the road surface shape recognition system of the first embodiment;

FIG. 5 is a diagram showing an outline of irradiation control device processing in the road surface shape recognition system of the first embodiment;

FIG. 6 is a diagram showing an example of a road surface state irradiated with extraneous light of a plurality of wavelength regions (λ₁, λ₂, λ₃) in the first embodiment;

FIG. 7 is a diagram showing the wavelengths and intensity that the extraneous light of the wavelength regions (λ₁, λ₂, λ₃) exhibits during the irradiation of the road surface in the first embodiment;

FIG. 8 is a flowchart for explaining an example of a recognition operation by the road surface shape recognition system of the first embodiment;

FIG. 9 is a waveform diagram that shows timing in which an area irradiated with next spot light during image data acquisition is predicted using a host vehicle current position and other information determined by a self-position estimating device in the first embodiment;

FIG. 10 is a diagram showing in detail the prediction operation of the area irradiated in the first embodiment;

FIG. 11 is an explanatory diagram of linear slit light in a road surface shape recognition system according to a second embodiment of the present invention;

FIG. 12 is an explanatory diagram of irradiation with the linear slit light from the road surface shape recognition system mounted on an autonomous mobile vehicle in the second embodiment; and

FIG. 13 is a diagram showing an example of a relationship between the linear slit light from the road surface shape recognition system of the second embodiment and a road surface irradiated with the light.

### MODE FOR CARRYING OUT THE INVENTION

Hereunder, road surface shape recognition systems according to embodiments of the present invention, and autonomous mobile apparatuses using one of the systems will be described in detail referring to the accompanying drawings.

### First Embodiment

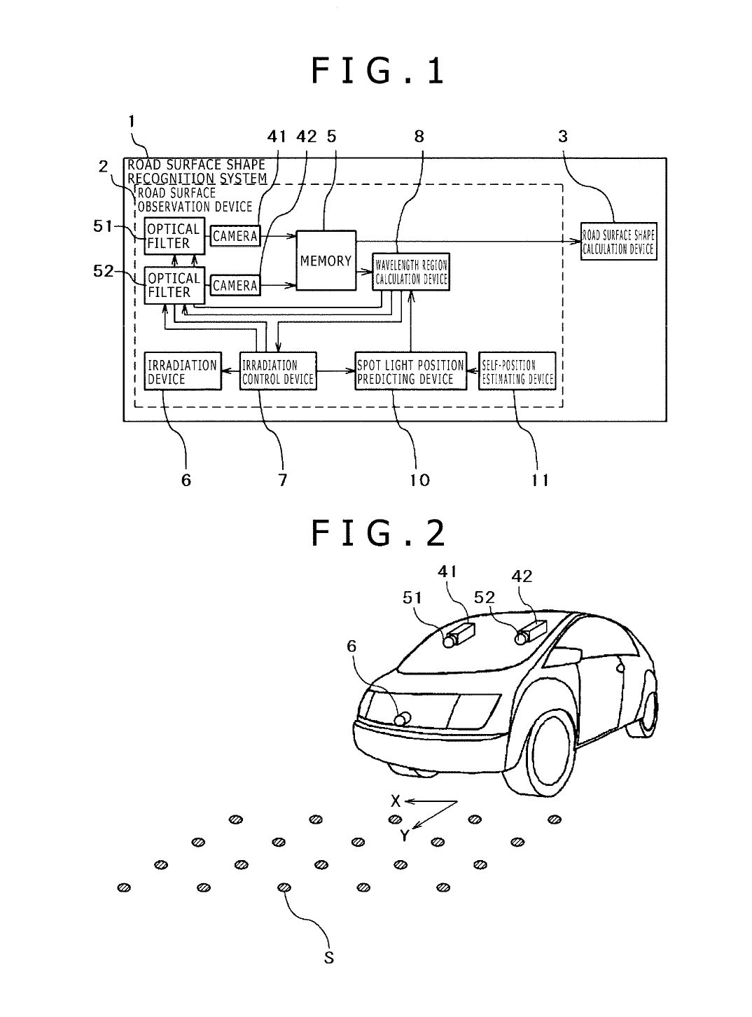

FIG. 1 is a block diagram showing a configuration of a road surface shape recognition system 1 which is a first embodiment of the present invention. That is to say, the road surface shape recognition system 1 of the present embodiment is mounted on an autonomous mobile vehicle as shown in FIG. 2, and the system is used for the autonomous mobile vehicle to reliably recognize a shape of a road surface and obstacles present ahead of the vehicle, and thus to perform functions such as generating a route, avoiding obstacles, and estimating a position of the vehicle itself.

The road surface shape recognition system 1 of the present embodiment is composed mainly of a road surface observation device 2 and a road surface shape calculation device 3, as shown in FIG. 1.

The road surface observation device 2 includes: two cameras, 41 and 42, that images the forward road surface side of the vehicle used as the autonomous mobile body having the road surface shape recognition system 1 mounted thereupon; optical filters 51 and 52 mounted on the cameras 41, 42, respectively, to make only light of a specific wavelength pass through; a memory 5 in which image data acquired by the cameras 41, 42 will be saved; an irradiation device 6 that emits spot light towards the forward road surface side of the vehicle (in FIG. 2, an area irradiated with the spot light is shown as S); an irradiation control device 7 that controls the wavelengths and irradiation direction of the spot light applied from the irradiation device; a wavelength region calculation device 8 that calculates spectra from the acquired images; a spot light position predicting device 10 that predicts an irradiating position of the spot light which moves with the vehicle; and a self-position estimating device 11.

The road surface shape calculation device 3 calculates the shape of the road surface from a parallax image derived from the image data that the cameras 41, 42 have acquired.

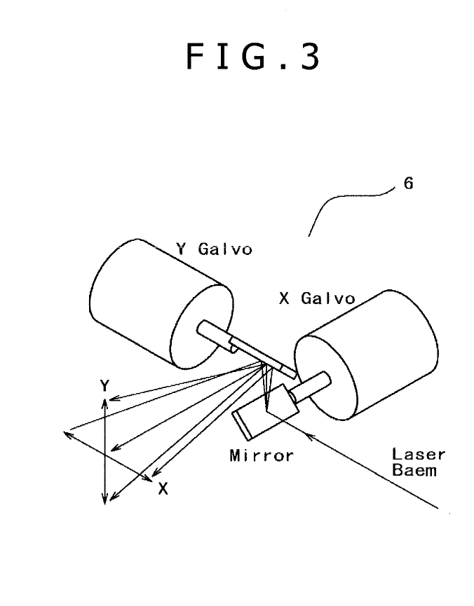

The irradiation device 6, consisting of, for example, a laser projector and the like, emits the spot light of the plurality of wavelengths towards a predetermined irradiating position. FIG. 3 shows a detailed configuration diagram of the irradiation device 6. As shown in FIG. 3, the irradiation device 6 has two galvanometers arranged at right angles, and can control, by moving mirrors of the galvanometers, an angle of reflection of laser light emitted from a wavelength-variable laser irradiation device 61, and thereby orient the laser light in any direction dictated by an X-axis and a Y-axis, in the figure.

The cameras 41, 42, by imaging the road surface ahead of the vehicle, additionally acquire image data that includes images of obstacles present on the road surface.

In addition, time division control, which will be detailed later herein, switches the irradiation device 6 from an irradiating state to a non-irradiating state, or vice versa. Accordingly, when the light including the plurality of wavelength regions is emitted from the irradiation device 6, the cameras 41, 42 acquire image data (irradiated-target image data) by receiving reflected light including both of the light resulting from reflection of the extraneous light from the forward road surface, and the light that has been reflected from the road surface. On the other hand, when the light including the plurality of wavelength regions is not emitted from the irradiation device 6, the cameras 41, 42 acquire image data (non-irradiated-target image data) by receiving reflected light including only the light resulted from the reflection of the extraneous light from the forward road surface.

The irradiated-target image data acquired by the cameras 41, 42 is stored into the memory 5. Only the non-irradiated-target image data obtained when the light is not emitted from the irradiation device 6, or both of the irradiated-target image data and the non-irradiated-target image data may be stored into the memory 5.

The wavelength region calculation device 8 derives the spectra of the reflections of the extraneous light while continuously varying light-transmission wavelength regions of the optical filters 51, 52, and derives a wavelength region of the weakest extraneous light from the spectra. Since the cameras 41, 42 here can increase respective frame rates to acquire image data of the forward road surface with respect to a larger number of transmission wavelength regions (corresponding to the spot light), each camera can enhance spectral resolution of the reflected light and hence determine wavelength regions of weak extraneous light very accurately.

The irradiation control device 7 makes the wavelength-variable laser irradiation device 61 emit the laser light of a plurality of wavelength regions. Each wavelength of the laser light is determined from the wavelength regions of the weak extraneous light that have been derived by the wavelength region calculation device 8. For example, the wavelengths selected here will be or may be a wavelength corresponding to the extraneous light of the lowest intensity that exists around the position irradiated with the spot light on the road surface ahead, and a wavelength of the broadest wavelength region in which the extraneous light has intensity lower than a threshold level.

The irradiation control device 7 also determines intensity of the laser light of the plurality of wavelength regions from the wavelength-variable laser light irradiation device 61, from the intensity of the extraneous light around the position irradiated with the spot light on the road surface ahead. Information on the intensity of the laser light as emitted from the wavelength-variable laser irradiation device 61 is sent to a spot light detection device and used to extract spot light from the image data acquired during the irradiation of the forward road surface by the cameras 41, 42.

Although this is not shown, the irradiation control device 7, wavelength region calculation device 8, spot light position predicting device 10, self-position estimating device 11, and further, road surface shape calculation device 3, in the road surface shape recognition system 1, may each be formed as or may be partly integrated as an arithmetic element such as a CPU. In this case, the arithmetic element will execute predetermined processing with pre-stored software or the like.

Next, operation of the road surface shape recognition system 1 according to the present embodiment is described in further detail below.

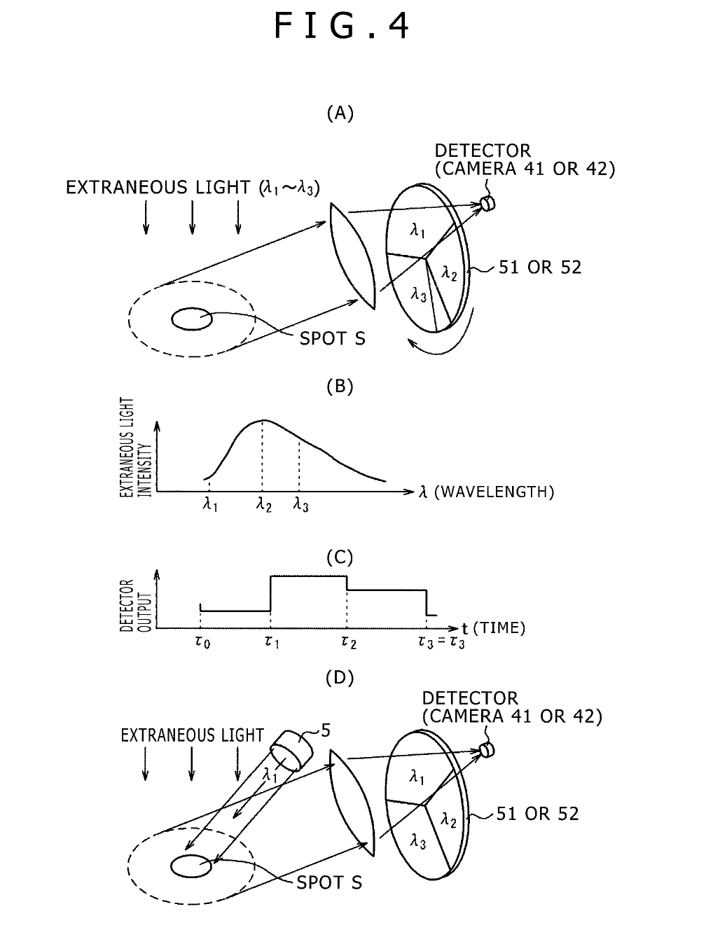

Processing in the wavelength region calculation device 8 and the irradiation control device 7 is first outlined below using FIGS. 4(A) to 4(D). How the recognition system selects a wavelength of the laser light emitted from the wavelength-variable laser light irradiation device 61 is described per FIGS. 4(A) to 4(D). (The way the laser light wavelength is selected)

First as shown in FIG. 4(A), when the road surface is illuminated only with the extraneous light (having the plurality of wavelength regions λ₁ to λ₃), and not illuminated with spot light, spot 9 and light from its periphery (i.e., reflected light) are converged by, for example, a lens or any other appropriate optical element, as shown, and then detected via the optical filter 51 or 52 (in the figure, a rotary type of disc-shaped filter with transmission regions λ₁, λ₂, λ₃) by a detector, or the camera 41 or 42. At this time, while rotating the optical filter for changing the transmission region of the filter to λ₁, λ₂, and λ₃, in that order, the detector detects intensity of the spot S and that of the extraneous light reflected from the periphery of the spot.

For example, if the intensity of the extraneous light exhibits such a spectral distribution as shown in FIG. 4(B), detection results that the detector obtains after the light has penetrated the optical filter will appear as shown in FIG. 4(C). That is to say, the intensity detected (detector output) during a time period of τ₀ to τ₁ (the passage of the light through the transmission region λ₁) will be lower than the intensity detected during other time periods of τ₁ to τ₂ (passage through the transmission region λ₂) and τ₂ to τ₃ (passage through the transmission region λ₃). In other words, the detector output during the time period of τ₀ to τ₁ will be the smallest of the three detection results. This example indicates that in the range of the wavelength regions λ₁ to λ₃, the spot 9 during the non-irradiating system state and the light reflected from the periphery of the spot have the lowest intensity in a neighborhood of the wavelength λ₁.

In the present invention, therefore, for improved detection ratio of the road surface shape and obstacles later irradiated with the spot light S, the wavelength of the laser light which is the spot light S later irradiated from the irradiation device 6 is set to the wavelength λ₁ or to the neighborhood thereof. The transmission wavelength region that the optical filter 51 or 52 is to use when the camera 41 or 42 that is the detector detects the corresponding spot light S is also set to the wavelength λ₁. In accordance with these principles of laser wavelength selection, even on the road illuminated with such extraneous light of a plurality of wavelengths that is emitted from road-illuminating lamps, street lamps, electric signboards, and the like, the shape of the road surface and obstacles present thereupon are reliably and well recognized without being adversely affected by the extraneous light.

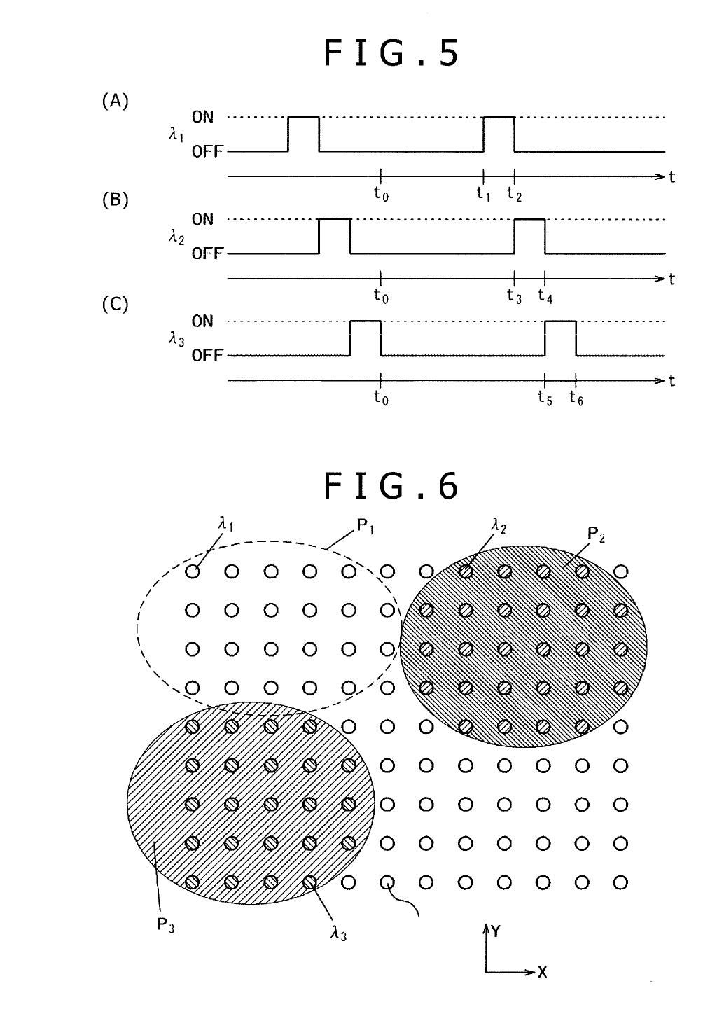

FIG. 5 is a diagram showing an outline of processing in the irradiation control device 7. FIG. 5(A) indicates that laser light of the wavelength region λ₁ is selected, FIG. 5(B) indicates that laser light of the wavelength region λ₂ is selected, and FIG. 5(C) indicates that laser light of the wavelength region λ₃ is selected. At time t₀ to t₁ in these figures, that is, during the time period of τ₀ to τ₃ in FIG. 4(C), the wavelength region calculation device 8 calculates the spectra of the reflected extraneous light while continuously varying the light-transmission wavelength region of the optical filter 51 or 52. After that, the irradiation control device 7 makes the irradiation device 6 generate, at time t₁ to t₂, the laser light of the wavelength λ₁, at time t₃ to t₄, the laser light of the wavelength λ₂, and at time t₅ to t₆, the laser light of the wavelength λ₃.

FIG. 6 shows an example of a road surface state irradiated with the extraneous light of the plurality of wavelength regions (λ₁, λ₂, λ₃). This example shows spectra of the extraneous light reflected from the road surface ahead of the vehicle, the spectra being obtained when the camera 41, 42 acquires image data (non-irradiated-target image data) by imaging this reflected extraneous light under the non-irradiating state of the irradiation device 6 not emitting any spot light. That is to say, the example shows a different spectral distribution for each of the plurality of areas P₁, P₂, P₃.

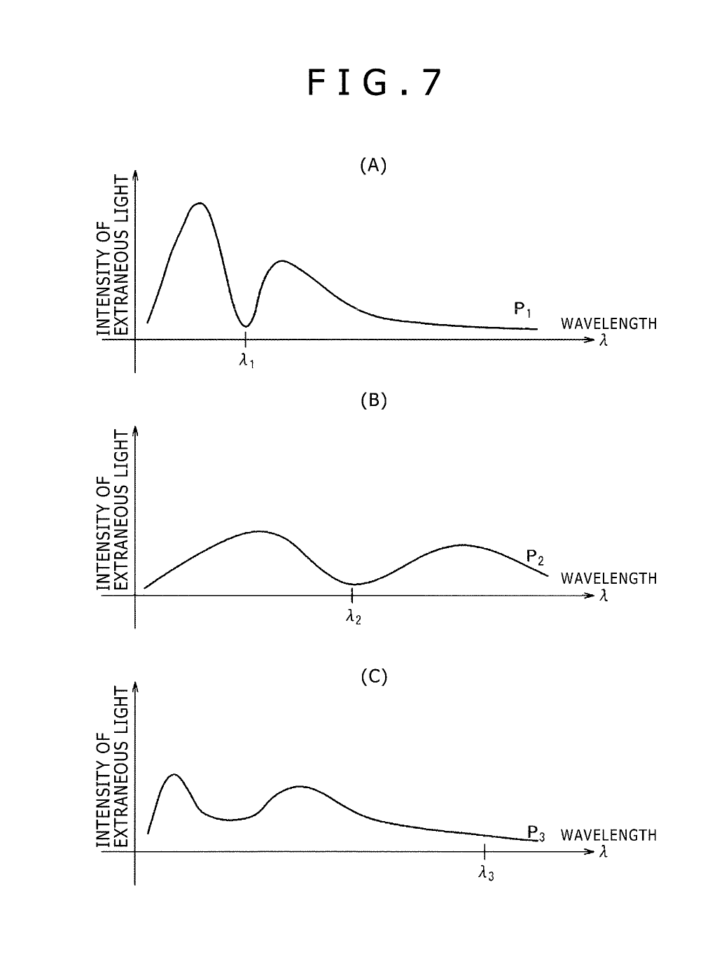

To be more specific, as shown in FIG. 7, in the area P₁, the extraneous light of the lowest intensity has the wavelength λ₁, so the irradiation control device 7 makes the irradiation device 6 generate the laser light of the wavelength λ₁ at the time t₁ to t₂ shown in FIG. 5(A), and the irradiation device 6 shown in FIG. 3 irradiates the predetermined position with the spot light. In addition, in the area P₂, the extraneous light of the lowest intensity has the wavelength λ₂, so the irradiation control device 7 makes the irradiation device 6 generate the laser light of the wavelength λ₂ at the time t₃ to t₄ shown in FIG. 5(B), and the irradiation device 6 irradiates the predetermined position with the spot light. Furthermore, in the area P₃, the extraneous light of the lowest intensity has the wavelength λ₃, so the irradiation control device 7 makes the irradiation device 6 generate the laser light of the wavelength λ₃ at the time t₅ to t₆ shown in FIG. 5(C), and the irradiation device 6 irradiates the predetermined position with the spot light.

At the same time, the light-transmission wavelength region of the optical filter 51 or 52 is also changed to fit the wavelengths λ₁, λ₂, λ₃ of the emitted laser light which has been selected above. More specifically, the light-transmission wavelength region is changed to λ₁ at the time t₁ to t₂ in FIG. 5(A), λ₂ at the time t₃ to t₄ in FIG. 5(B), and λ₃ at the time t₅ to t₆ in FIG. 5(C).

It has been described above by way of example that the optical filter 51 or 52 is the rotary type of disc-shaped filter having three variable wavelength regions λ₁, λ₂, λ₃, but the kind of optical filter 51 or 52 is not limited to the description. Instead, a filter without a movable section and enabling the selection of wavelengths from candidates continuously variable in the range of λ₁ to λ₃, for example, may be used. For example, the optical filter can be the liquid-crystal tunable filter (LCTF) by Cambridge Research and Instrumentation (CRI), Inc., USA, known under the trade name of VariSpec™ and featuring an electrical wavelength-tuning capability in addition to the use of no moving parts. This filter, constructed by stacking a polarizer and a nematic liquid crystal upon each other, allows a peak wavelength to be changed optionally and rapidly by making an applied voltage variable. As a result, light of any wavelength component to be extracted.

In addition, the irradiation device 6 that emits the spot light described above is not limited to a type that selectively uses a plurality of laser light-generating elements different in wavelength The irradiation device 6 may be of a type that continuously generates laser light of desired wavelengths (λ₁ to λ₃) using the above liquid-crystal tunable filter.

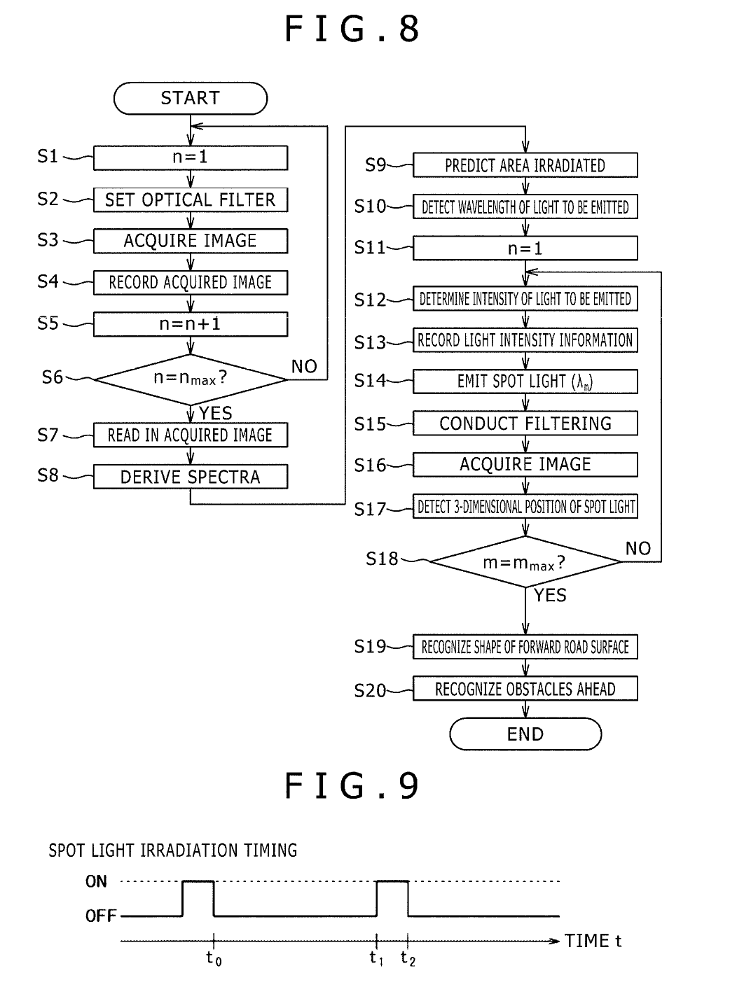

Next, an example of a recognition operation by the road surface shape recognition system 1 whose detailed configuration has been described above is described below referring to FIG. 8.

As shown in FIG. 8, when the recognition operation by the road surface shape recognition system 1 is executed by the CPU and other elements forming a part of the system, ‘1’ is first assigned as a number ‘n’ to denote a wavelength region (step S1).

Next, the wavelength region calculation device 8 sets the light-transmission wavelength region of the optical filter 51 or 52 to a wavelength region corresponding to ‘n=1’ (step S2). After this, one or both of the cameras 41, 42 image the forward road surface (step S3). This makes the wavelength region calculation device 8 acquire image data, or intensity data relating to the reflected light in the wavelength region corresponding to ‘n=1’. Next, the image that the camera 41 or 42 has acquired is stored into the memory 5 (step S4).

The wavelength region calculation device 8 next increments the number ‘n’ denoting the wavelength region (step S5).

After that, the wavelength region calculation device 8 determines whether the number ‘n’ denoting the wavelength region equals the number of observations, ‘Nₘₐₓ’, needed to acquire the spectrum of the reflected light, that is, the number of spots S shown in FIG. 6 (step S6). If, as a result, the number ‘n’ denoting the wavelength region is determined not to equal ‘Nₘₐₓ’, that is, if the determination in step S6 is negative (NO), processing returns to step S2.

Conversely if the number ‘n’ denoting the wavelength region is determined to equal ‘Nₘₐₓ’, that is, if the determination in step S6 is positive (YES), then in step S7 the wavelength region calculation device 8 reads in from the memory 5 the image data that was acquired in step S3.

After reading out the image data, the wavelength region calculation device 8 calculates in step S8 the spectra of the extraneous light in each image area (spot S).

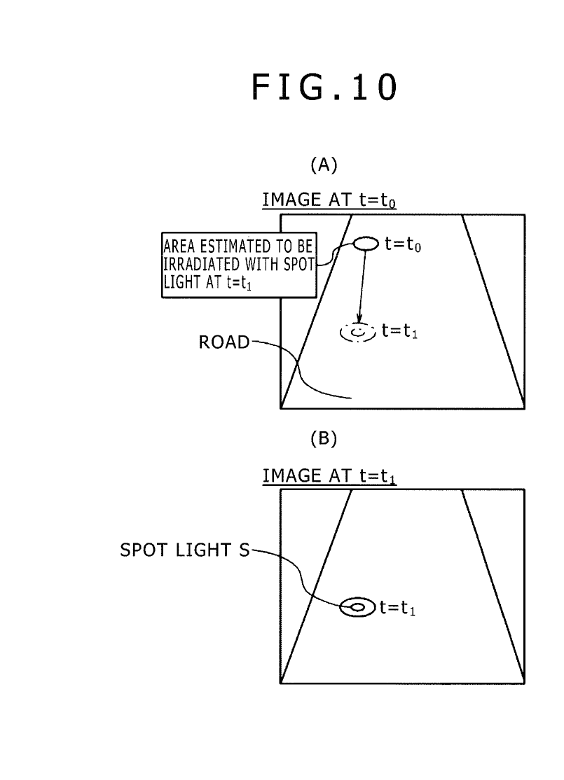

Next as shown in FIGS. 9, 10(A), and 10(B), in step S9, an area that will be irradiated with the next spot light during image data acquisition is predicted from the current position of the vehicle that the self-position estimating device 11 has estimated, speed data such as a traveling speed and angular velocity of the vehicle, and further, acceleration data such as positive acceleration and angular acceleration of the vehicle.

After the prediction, the wavelength region calculation device 8 detects, from the spectrum of the reflected light in the image area which was predicted in step S10, the wavelength of the weakest extraneous light in that area (step S10).

At the same time, in step S12, the wavelength region calculation device 8 determines the intensity of the spot light, based upon the spectrum of the extraneous light that was derived in step S9, and in step S13, stores into the memory 5 the determined intensity information relating to the spot light to be emitted.

Next, in step S14, the irradiation device 6 irradiates the predetermined position on the forward road surface with the spot light of the wavelength which was detected in step S11.

The spot light that was used to irradiate the predetermined position in step S14 is filtered in the band including the wavelength of the spot light, by the optical filter 51 or 52 (step S15), and then imaged by the paired cameras 41, 42 (step S16).

After this, a three-dimensional position of the spot light is identified from the parallax of the images which the cameras 41, 42 have acquired by imaging the same spot light (step S17). During this detection of the same spot light, the spot light intensity information that was stored in step S13 is desirably utilized to improve the detection ratio of the spot light.

Alternatively, if, as when the road surface ahead is irradiated with the extraneous light from a plurality of illumination sources, the wavelength of the weakest extraneous light differs between individual areas on the road surface, independent spot light having one of the different wavelengths (λ₁ to λₘₐₓ) is used to irradiate each road surface area, and thus the three-dimensional position of the spot light is identified (steps S11 to S18).

Next, on the basis of the three-dimensional position of the spot light that was identified in step S17, the shape of the forward road surface is determined (step S19), and finally, any obstacles present on the road surface are extracted (step S20).

This completes processing shown in FIG. 8. Processing shown in FIG. 8 is repeated until electric power to the road surface shape recognition system 1 has been turned off (interrupted).

In the road surface shape recognition system 1 of the present embodiment that has the above-described configuration, as in a street, even under an environment that extraneous light of a plurality of wavelength regions is shining upon the road surface, each area being irradiated with the extraneous beams of light can be irradiated, from the irradiation device 6, with any beam of light of a wavelength region corresponding to the extraneous light of low intensity, in other words, light of the wavelength region where it is insusceptible to the influence of the extraneous light. The shape of the road surface, therefore, is efficiently recognized according to the particular intensity of the extraneous light.

The configuration including, for example, not only the cameras 41, 42 but also the optical filters 51, 52 in combination, for imaging the forward road surface side of the vehicle, has been described above. This configuration, however, does not limit the present invention, and these elements may be replaced by two units, called hyper-spectral cameras, that are each designed so that the wavelengths of incoming light can be detected for each of cells constituting a photodetector in the camera. If these hyper-spectral cameras are adopted, the system 1 can derive a necessary spectrum just by conducting one imaging operation with the cameras, without deriving the spectra of the reflected light on the road surface imaged while varying the light-transmission wavelength regions of the optical filters. Thus, the processing time required can be shortened and the shape of the road surface can be recognized even when the vehicle is moving at a higher speed.

In the first embodiment described above, the paired cameras 41, 42 constituting the imaging device have been described as imaging the shape of the road surface and obstacles by, as shown in FIGS. 2 and 6, irradiating the road surface from the irradiation device 6 shown in FIG. 3, with a plurality of beams of spot light S in a predetermined sequential pattern, for example while sequentially scanning the plurality of areas on the road surface. The beams of spot light, however, may have their intervals changed according to the state of the road surface to be detected. More specifically, where the road surface is steeply undulated and thus the shape of the road surface requires more detailed examination, the intervals of the beams of spot light on the entire road surface or on part of the road surface may be narrowed or the slit light may be further reduced in diameter. Resolution of the road surface shape measurement will then be enhanced.

In addition, if as shown in FIGS. 9, 10(A), and 10(B), the area that will be irradiated with the next spot light during image data acquisition is predicted from the estimated current position of the vehicle, the calculated speed data such as the traveling speed and angular velocity of the vehicle, and further, the calculated acceleration data such as the positive acceleration and angular acceleration of the vehicle, to detect the wavelength of the weakest extraneous light in that area, then the shape of the road surface can be recognized more reliably, even when the vehicle is moving at an even higher speed.

### Second Embodiment

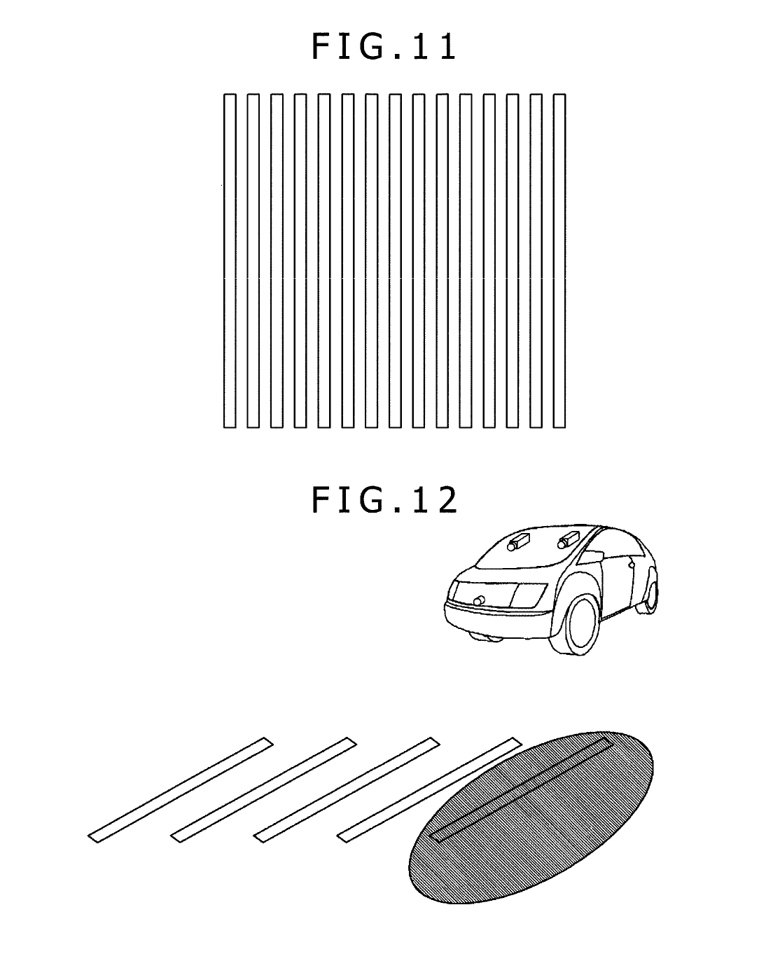

Hereunder, a road surface shape recognition system according to a second embodiment of the present invention, and an autonomous mobile apparatus using the system will be described per FIGS. 11 to 13. The road surface shape recognition system in the present embodiment has substantially the same configuration as that described above, and description of the system configuration is therefore omitted herein.

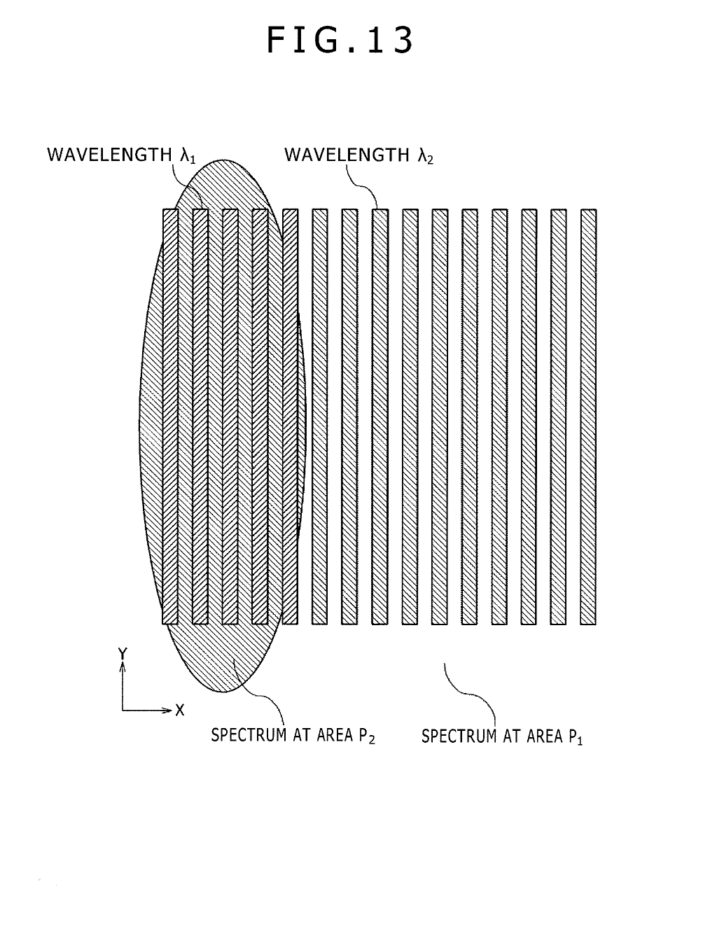

In the present embodiment, instead of the circular spot light emitted from the irradiation device 6 towards the road surface, as shown in FIGS. 2 and 6, a plurality of linear beams of light (hereinafter, referred to as slit light) that extend in a direction of a Y-axis, as is evident from FIGS. 11 and 12, are employed for a simplified configuration of the irradiation device 6. In accordance with the present embodiment, as shown in FIG. 13, even in cases that extraneous light is emitted mainly from a side of the road or that the road surface is divided in the traveling direction (Y-direction) of the vehicle by one or a plurality of areas having substantially the same spectrum of reflected light, each area being irradiated with the extraneous light can be efficiently irradiated with light of a wavelength region corresponding to the extraneous light of low intensity, in other words, light of the wavelength region where the light when emitted from the irradiation device 6 is insusceptible to the influence of the extraneous light. Hence, the shape of the road surface and obstacles present thereupon are reliably and well recognized without being adversely affected by the extraneous light.

In the present embodiment, as in the first embodiment that uses spot light, for example if the road surface is steeply undulated and thus the shape of the road surface requires more detailed examination, intervals between the beams of slit light on the entire road surface or on part of the road surface are also narrowed. This enhances the resolution of the road surface shape measurement.

While the description of the present invention, based upon the above embodiments, has been given above, it will be apparent to persons skilled in the art, that the invention is not limited to the embodiments and that, changes and modifications may be induced without departing from the scope of the invention.

### DESCRIPTION OF REFERENCE NUMERALS

1 . . . Road surface shape recognition system, 2 . . . Road surface observation device, 3 . . . Road surface shape calculation device, 5 . . . Memory, 6 . . . Irradiation device, 7 . . . Irradiation control device, 8 . . . Wavelength region calculation device, 10 . . . Spot light position predicting device, 11 . . . Self-position estimating device, 41, 42 . . . Cameras, 51, 52 . . . Optical filters

1. A road surface shape recognition system for recognizing a shape of a road surface ahead of a vehicle, the system comprising:
wavelength region calculation means for detecting extraneous light from a plurality of areas on the road surface, and thereby determining a wavelength region of the extraneous light having the lowest intensity;
irradiation means for irradiating each of the areas on the road surface selectively with light of one of a plurality of wavelength regions;
irradiation control means for selecting, from the light of the plurality of wavelength regions that can be selectively irradiated from the irradiation means, light having a wavelength corresponding to the wavelength region of the weakest extraneous light, the wavelength region being determined by the wavelength region calculation means, and making the irradiation means emit the selected light;
imaging means for imaging the road surface; and
road surface shape calculation means for calculating the shape of the road surface from an image that the imaging means acquires when the irradiation means is irradiating one of the areas on the road surface with the light of the wavelength selected by the irradiation control means.

2. The road surface shape recognition system according to claim 1, wherein:
on the basis of the image that the imaging means acquires when the irradiation means is not irradiating the road surface, the wavelength region calculation means detects the extraneous light and determines the wavelength region of the extraneous light having the lowest intensity.

3. The road surface shape recognition system according to claim 2, wherein:
the imaging means images the road surface while sequentially causing the wavelength region calculation means to execute the detection of the wavelength region of the weakest extraneous light, and the irradiation control means and the irradiation means to execute respectively the selection of light having a wavelength corresponding to the wavelength region of the weakest extraneous light, and irradiation with the selected light.

4. The road surface shape recognition system according to claim 3, wherein:
the wavelength region calculation means determines, from information relating to a motion of the vehicle, the wavelength region of the weakest extraneous light on a predicted area of the road surface.

5. The road surface shape recognition system according to claim 4, wherein:
the irradiation means is adapted to irradiate the road surface selectively with the light of the plurality of wavelength regions as a plurality of beams of spot light or slit light.

6. The road surface shape recognition system according to claim 5, wherein:
a size or intervals of the beams of spot light or slit light are changed according to a state of the road surface detected.

7. The road surface shape recognition system according to claim 6, wherein:
the wavelength region calculation means is shared with the imaging means and fitted with a filter to selectively let the extraneous light from the plurality of areas on the road surface pass through.

8. The road surface shape recognition system according to claim 7, wherein:
the irradiation control means, while sequentially scanning the plurality of areas on the road surface, selects light having a wavelength corresponding to the determined wavelength region of the weakest extraneous light, and makes the irradiation means emit the selected light.

9. The road surface shape recognition system according to claim 8, wherein:
the irradiation means includes a galvanometer for emitting the light while sequentially scanning in accordance with a control signal from the irradiation control means.

10. An autonomous mobile apparatus adapted to autonomously move along the road surface while recognizing the shape of the road surface, the apparatus being equipped with the road surface shape recognition system of claim 1.
